(19) United States
(12) Patent Application Publication
(10) Pub. No.: US 2010/0090422 A1
(43) Pub. Date: Apr. 15, 2010

(54) REAR-WHEEL SKATING SHOE

(76) Inventors: Wai-Shing Chan, Guangdong (CN); Wei-Quan Chen, Guangdong (CN); Wei-Pei Chen, Guangdong (CN)

Correspondence Address: Dr. BANGER SHIA;Patent Office of Bang Shia, 102 Lindencrest Ct., Sugar Land, TX, 77479-5201, US

(21) Appl. No.: 11/993,964

(22) PCT Filed: Apr. 29, 2007
(86) PCT No.: PCT/CN07/01450

§ 371 Date: Dec. 26, 2007

(30) Foreign Application Priority Data
Jul. 4, 2006 (CN) 200620061214.0
Sep. 30, 2006 (CN) 200620065285.8

(51) Int. Cl. A63C 17/00; F21V 21/08

(52) U.S. Cl. 280/11.27; 362/103

(57) ABSTRACT

A rear-wheel skating shoe provides an enhanced shoe stand with a single fulcrum for a wheel axle to make the structure at positions between a sidewall and a wheel axle and between a sidewall and a bottom plate of the shoe stand stronger to facilitate exposing luminous wheels and protect a user's safety effectively. The shoe includes a left shoe stand, a right shoe stand, a metal screw rod at external sidewalls of the shoe stands, a luminous wheel on the metal screw rod, a left reinforced stand in a sidewall of the left shoe stand, a right reinforced stand in a sidewall of the right shoe stand, and a reinforced plate at the bottom of the bottom plate of the shoe stand and connected to the right reinforced stand. The metal reinforced elements of the skating shoe give a strong structure, and the luminous wheels provide a color effect.

### BACKGROUND OF THE INVENTION

1. Field of the Invention

The present invention relates to a rear-wheel skating shoe, and more particularly to a skating shoe having a single-fulcrum axle installed to the bottom of a shoe, reinforced structures installed between wheels, axles and support stands, and a protecting device installed at a coil of wheel-core electric generator of the wheels.

2. Description of the Related Art

Rear-wheel skating shoes are very popular worldwide and become favorable sports machinery to most people, particularly to youngsters. The use of this skating shoe is not limited by sites, and thus people can enjoy the fun of skating on a flat floor and use the shoes as a quick and convenient transportation means. People can wear the rear-wheel skating shoes for skating and shopping along a street or going outdoors for a trip. A regular skating shoe is usually tied onto the bottom of a weari s shoe b a shoe lace, but the design of the present rear-wheel skating shoes is very complicated, and the product structure generally comes with an arc loop at an external side of a stand of a shoe body, a wheel axle fixing gear, and a slide wheel disposed in the arc loop. The production has a high cost and consumes lots of materials, particularly when if a light emitting wheel is installed at the slide wheel, and the arc loop outside the stand of the shoe body blocks ⅓ of the light, weakens the color effect of the light emitting skating shoes, and affects the external aesthetic look and the fun of the skating shoes. In addition, the light emitting wheel body of the rear-wheel skating shoe is made of plastic, so that when a user wears and skates the shoes, uneven forces are exerted on the shoes, and deformations, short circuits and falling outs may occur easily at connecting positions of a coil, a circuit board and a light emitting diode. For a worse situation, the whole coil or circuit board may even be broken, and the user no longer can use the shoes nor enjoy the fun of the skating shoes. Furthermore, the electromagnetic inductive light emitting wheel provided in the present light emitting wheel mainly installs a magnet on the internal periphery of the bearing, a wheel core casing at the external periphery of the bearing, and a sensing coil fixed in the wheel core casing, such that the bearing can be rotated to produce electromagnetic inductive current and supply power to the light emitting diode for emitting light onto the wheel. However, the electric generating device in this type of wheel core does not have the protection an independent casing, and the inductive coil frame may be short-circuited easily due to the collisions, and the coil may be damaged easily to lose the light emitting function.

Some manufacturers also developed single-fulcrum wheel skating shoes, wherein an end of the wheel is fixed onto an external sidewall of a support stand of the shoe body, and another end of the wheel is suspended, such that the external side of the light emitting wheel is exposed completely from the support stand of the shoe body, and the light emitting wheel can emit a full color light right, but a shoe stand of the rear-wheel skating shoe is generally made of plastic materials, and thus the connecting position of the side wall of the shoe stand and the wheel is relatively weaker, such that when a user glide and stride on the skating shoe, uneven forces will be exerted onto the sidewall, and deformations may occur easily at the connecting positions of the sidewall of the shoe stand and the wheel, and the side wall of the shoe stand and the bottom plate of the shoe stand, and the sidewall of the shoe stand and the wheels and the sidewall of the shoe stand and the bottom plate of the shoe stand may be broken easily. As a result, users no longer can use and enjoy the fun of the skating shoe, and accidents may occur easily.

### SUMMARY OF THE INVENTION

In view of the foregoing shortcomings of the prior art, the inventor of the present invention based on years of experience in the related industry to conduct extensive researches and experiments, and finally developed a rear-wheel skating shoe in accordance with the present invention to overcome the foregoing shortcomings of the prior art.

The primary objective of the present invention is to provide a rear-wheel skating shoe that enhances the structure, such that the structures at the connecting positions of the sidewall of the shoe stand and the wheel, the sidewall of the shoe stand and the bottom plate of the shoe stand become stronger to facilitate the light emitting wheel to be exposed easily, so that the running light emitting wheel can achieve the effect of emitting a full color light ring. An independent external casing is disposed outside the coil of electric generator in the light emitting wheel, so that the coil, circuit board and light emitting diode can have stronger connection, and the invention can enhance the popularity and promotion of products and effectively protect the useri s sfety while using the skating shoes.

To achieve the foregoing objective, the present invention provides a rear-wheel skating shoe comprising: a left shoe stand, a right shoe stand, a metal screw rod disposed on sidewalls of the right and left shoe stands, a light emitting wheel installed on the metal screw rod, a left reinforced stand installed in the sidewall of the left shoe stand, a right reinforced stand installed in the sidewall of the right shoe stand, and a reinforced plate installed at the bottom plate of the right shoe stand.

Further, the bottom of a pedal of the left shoe stand has a press switch, and the press switch has a latch paw disposed at an end of the press switch, and the press switch is passed through an axle hinged left shoe stand, and the bottom of the pedal of the right shoe stand has a plurality of ratcheted positioning latch, and the end of the press switch on the left shoe stand is pressed onto a vertical surface of the ratcheted positioning latch on the bottom plate of the left shoe stand. The left reinforced stand, the right reinforced stand, and the reinforced plate are made of metals. The left shoe stand with the left reinforced stand covered with a plastic material, the right reinforced stand, and the right shoe stand with the right reinforced stand and reinforced plate covered with a plastic material have a common wheel axle hole disposed on the left reinforced stand and the sidewall of the left shoe stand, and a metal screw rod is passed through the sidewall of the right shoe stand and has a light emitting wheel installed at a position exposed from the external sidewall, and the metal screw rod is passed through the sidewall of the right shoe stand and has a light emitting wheel installed at a position exposed to the outside, and the light emitting wheel is fixed onto the metal screw rod by screws.

Further, a distal portion of the reinforced plate has a penetrating hole, and the bottom of the right reinforced stand has a penetrating hole, and a fixing axle is installed in the penetrating hole and passed through the through hole between the right reinforced stand and the reinforced plate, and the right reinforced stand and the reinforced plate are integrally formed into a structure made by metal manufacturing.

Further, the bottom of the left shoe stand is connected to the E-shaped bottom plate, and the metal screw rod is passed through the left shoe stand and extended into the E-shaped bottom plate, and another metal screw rod is passed through the right shoe stand and extended into the n-shaped bottom plate,

Further, a lateral of the E-shaped bottom plate of the left shoe stand has a traveling slot, and a lateral of the bottom plate of the n-shaped bottom plate of the right shoe stand has a traveling screw extended into the traveling slot. The left shoe stand and the E-shaped bottom plate are integrally formed into a structure made by metal manufacturing. The metal screw rod is extended into the protruding pillar of the E-shaped bottom plate, and another metal screw rod is extended into the n-shaped bottom plate and at a position proximate to the n-shaped opening.

The light emitting wheel includes an upper protecting casing and a lower protecting casing, wherein the upper and lower protecting casings are engaged to form a hollow box and form a module consisting of a lower conducting stand, an upper conducting stand and a coil.

The upper protecting casing includes a circuit board disposed on an external lateral of the upper protecting casing, an insert pillar disposed at an end of the internal lateral of the upper protecting casing, an U-shaped opening disposed at an end of the internal lateral of the upper protecting casing, and a light emitting diode tube disposed in the U-shaped opening. The lower protecting casing includes an insert hole disposed at an end of the internal lateral of the lower protecting casing, a U-shaped opening disposed at an end of the internal lateral of the lower protecting casing, and the insert pillar of the upper protecting casing corresponds to the insert hole of the lower protecting casing, such that when the upper and lower protecting casings are engaged with each other, the insert pillar is fixed into the insert hole.

The upper and lower protecting casings include a T-shape surface at an end of the external laterals of the upper and lower protective casings respectively for improving the brightness of the light emitting diode tube. The U-shaped opening of the upper protecting casing has a light emitting diode tube with a lamp head pointing at the external lateral of the upper protecting casing. The U-shaped opening of the upper protecting casing has a light emitting diode with a lamp head pointing at the top of the upper protecting casing.

Compared with the prior art, the shoe stand of the skating shoe in accordance with the present invention has metal reinforced elements, such that the structures between the sidewall of the shoe stand and the wheel axle, the sidewall of the shoe stand and the bottom plate of the shoe stand become stronger. In addition, a metal screw rod is installed in the bottom plate of the skating shoe, so that the structure at the connecting position of the shoe stand and the bottom plate become stronger and provide a higher safety coefficient. Both shoe stand and bottom plate are made of plastic materials and integrally formed by plastic molding, so that the shoe stand and the bottom plate will not be deformed easily, and also provide a high safety coefficient, regardless of the skating shoes being used by men, women, elderly people or youngsters. In the meantime, an end of the wheel axle of the skating shoe is fixed to an external sidewall of a support stand of the shoe body, and another end is suspended. The wheel axle has a light emitting wheel, such that the external side of the light emitting wheel is exposed from the support stand of the shoe body, and the light emitting wheel can emit a full color light ring, so as to achieve the ideal effects of exercising in an environment of a colorful ring and providing lots of fun to users.

Another effect of the present invention resides on that the module consisting of a lower conducting stand, an upper conducting stand and a coil is enclosed by the upper and lower protecting casings, such that the connections at the coil module, the circuit board and the light emitting diode tube becomes stronger and will not be deformed easily. If the rear-wheel skating shoes with light emitting wheels are used by users for walking and bumped into something and busted, the coil module of the wheel is protected by the protecting casing, and the electromagnetic coil frame is also protected. Even if the electromagnetic coil frame is hit, the coil module will not be short circuited to maintain a long life expectancy. In addition, the structural design of the skating shoe is simple, easy-to-assemble, flexible, safe and reliable.

### BRIEF DESCRIPTION OF THE DRAWINGS

FIG. 1 is an exploded view of a first preferred embodiment of the present invention;

FIG. 2 is a schematic view of a structure in accordance with a first preferred embodiment of the present invention;

FIG. 3 is a schematic view of a structure of a reinforced portion in accordance with a first preferred embodiment of the present invention;

FIG. 4 is an exploded view of a structure of a reinforced portion in accordance with a first preferred embodiment of the present invention;

FIG. 5 a schematic view of a structure in accordance with a second preferred embodiment of the present invention;

FIG. 6 is an exploded view of a structure in accordance with a second preferred embodiment of the present invention;

FIG. 7 is a section view of a bottom portion of a shoe in accordance with a second preferred embodiment of the present invention;

FIG. 8 is a schematic view of a structure in accordance with a third preferred embodiment of the present invention;

FIG. 9 is a top view of a protecting box in accordance with a third preferred embodiment of the present invention;

FIG. 10 is an exploded view of a third preferred embodiment of the present invention;

FIG. 11 is a schematic view of an overall structure having three wheels in accordance with a third preferred embodiment of the present invention;

FIG. 12 is a schematic view of a structure of a fourth preferred embodiment of the present invention;

FIG. 13 a section view of a bottom portion of a shoe in accordance with a fourth preferred embodiment of the present invention; and

FIG. 14 is an exploded view of a fourth preferred embodiment of the present invention.

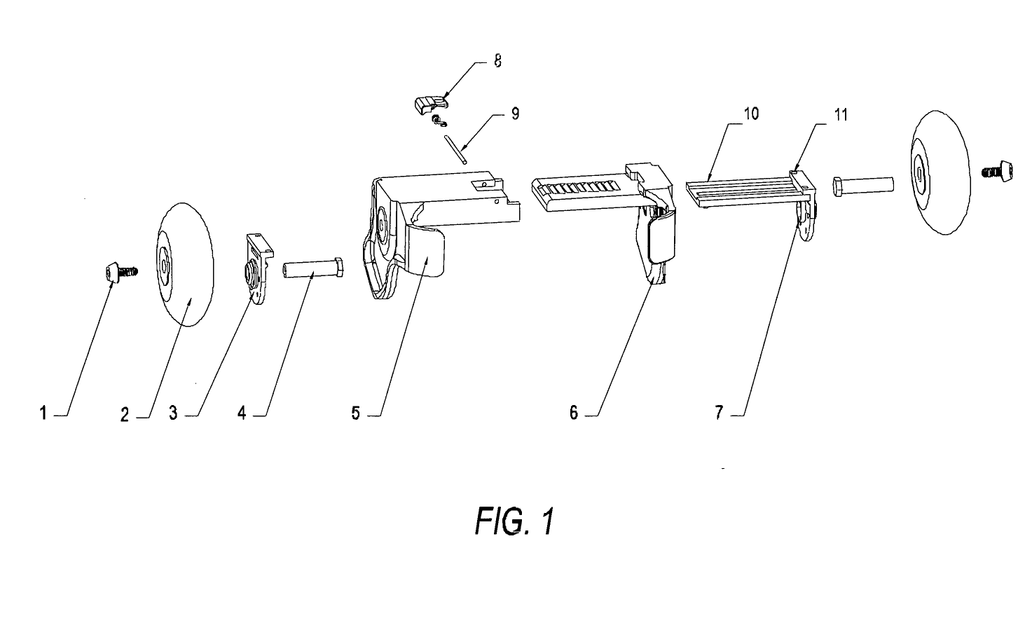

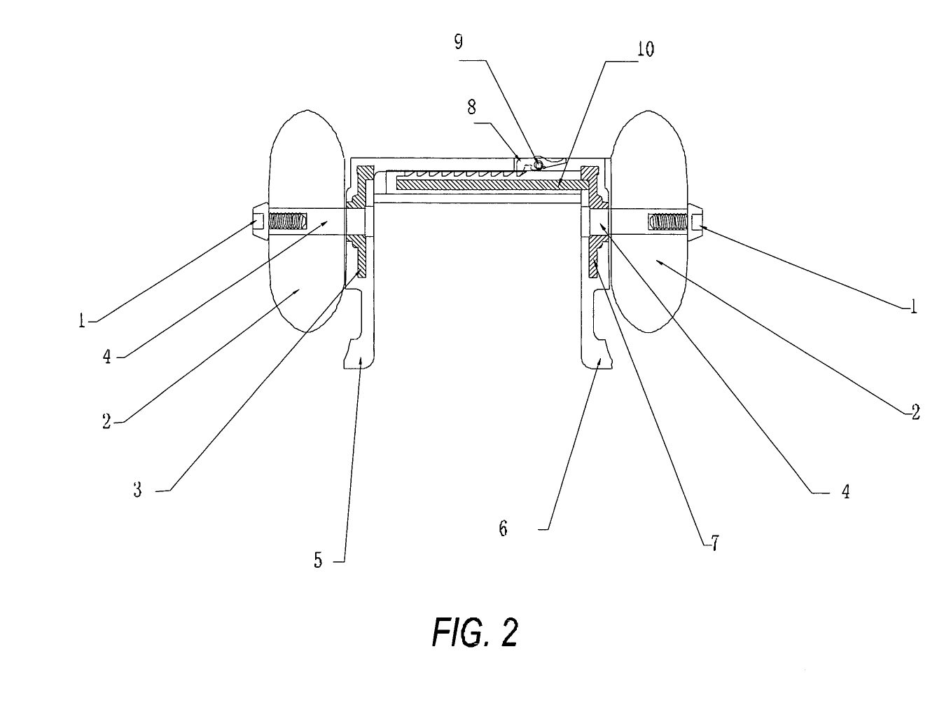

### DETAILED DESCRIPTION OF THE PREFERRED EMBODIMENTS

To make it easier for our examiner to understand the objective, shape, structure, apparatus, characteristics and performance of the present invention, the following detailed description with reference to the accompanying drawing of preferred embodiments is given for example, but such preferred embodiments are not intended to limit the scope of the present invention.

The related structure of the invention comprises the following components or devices, respectively: a screw 1, a light emitting wheel 2, a left reinforced stand 3, a metal screw rod 4, a left shoe stand 5, a right shoe stand 6, a right reinforced stand 7, a press switch 8, an axle 9, a reinforced plate 10, a fixed axle 11, a penetrating hole 12, a traveling screw 13, a traveling slot 14, an E-shaped bottom plate, an n-shaped bottom plate, an upper protecting casing 17, a lower conducting stand 18, an upper conducting stand 19, a lower protecting casing 20, a coil 21, a T-shape surface 23, a light emitting diode tube 24, a circuit board 25, a U-shaped opening 26 and an insert pillar 27.

In a first preferred embodiment of the present invention, the left and right shoe stands 5, 6 have the metal screw rod 4 disposed on external sidewalls of the left and right shoe stands 5, 6, and the metal screw rod 4 installs the light emitting wheel 2, and the sidewall of the left shoe stand 5 contains the left reinforced stand 3, and the sidewall of the right shoe stand 6 contains the right reinforced stand 7, and the bottom plate of the right shoe stand 6 contains the reinforced plate fixed to the right reinforced stand 7. The left reinforced stand 3, the right reinforced stand 7 and the reinforced plate 10 are made of metals, and the metal of the left reinforced stand 3 is covered by the left shoe stand 5 made of a color plastic material, and the metal of the right reinforced stand 7 and the reinforced plate 10 are covered by the right shoe stand 6 made of a color plastic material, so as to provide a better overall appearance of the skating shoe.

The left shoe stand 5 has the press switch 8 installed at the bottom of a pedal of the left shoe stand 5, and an end of the press switch 8 includes a latch paw, and the press switch 8 is passed through the axle 9 and hinged with the left shoe stand 5. The bottom of a pedal of the right shoe stand 6 includes a plurality of ratcheted positioning latches, and the press switch 8 of the left shoe stand 5 presses on a vertical surface of the ratcheted positioning latch on the bottom plate of the right shoe stand 6. If some portions of the left and right shoe stands 5, 6 are inserted into each other, an end of the press switch 8 on the left shoe stand 5 is pressed onto the ratcheted positioning latch on the right shoe stand 6, such that the left and right shoe stands 5, 6 cannot be extended and pulled apart from each other, and users can adjust the width of the skating shoe naturally, conveniently and quickly.

The left reinforced stand 3 and the left shoe stand 5 respectively have a common wheel axle hole disposed on sidewalls of the left reinforced stand 3 and the left shoe stand 5 for passing the metal screw rod 4, and the metal screw rod 4 is passed through the axle hole of the left shoe stand 5 and includes a light emitting wheel 2 installed at the portion exposed from the external sidewall, and an end of the metal screw rod 4 is fixed onto the external sidewall of the left shoe stand 5 and another end of the metal screw rod 4 is suspended. The metal screw rod 4 installs a light emitting wheel 2, such that the external side of the light emitting wheel 2 is exposed completely from the support stand of the shoe body, since the external side of the metal screw rod 4 towards the light emitting wheel 2 is suspended. Therefore, the light emitting wheel 2 can emit complete colorful lights to improve the aesthetic appearance and fun of the skating shoe. The invention also provides a blinking warning light for the safety purpose.

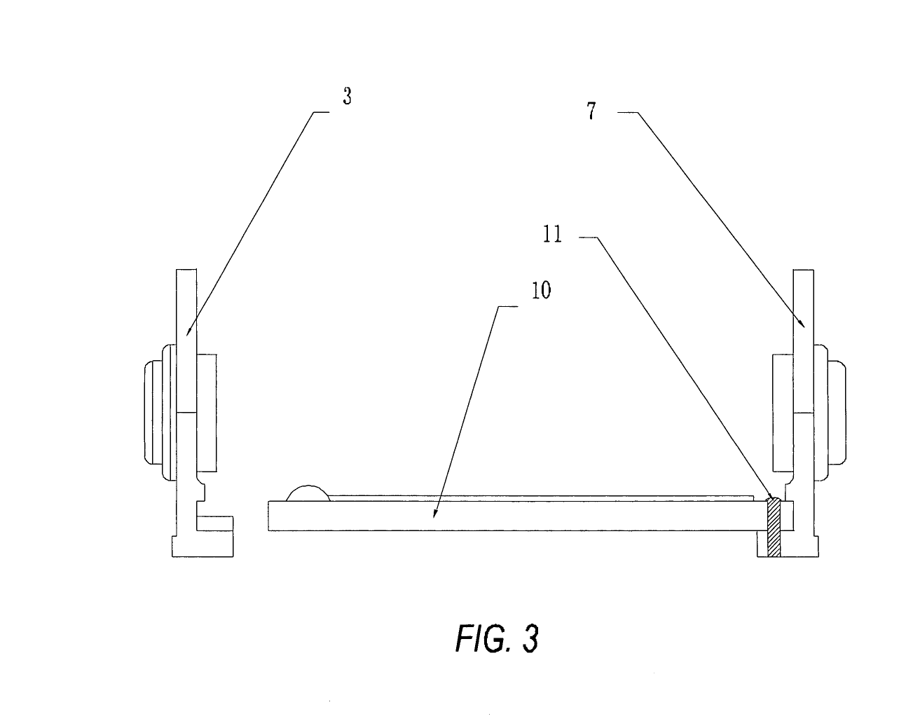

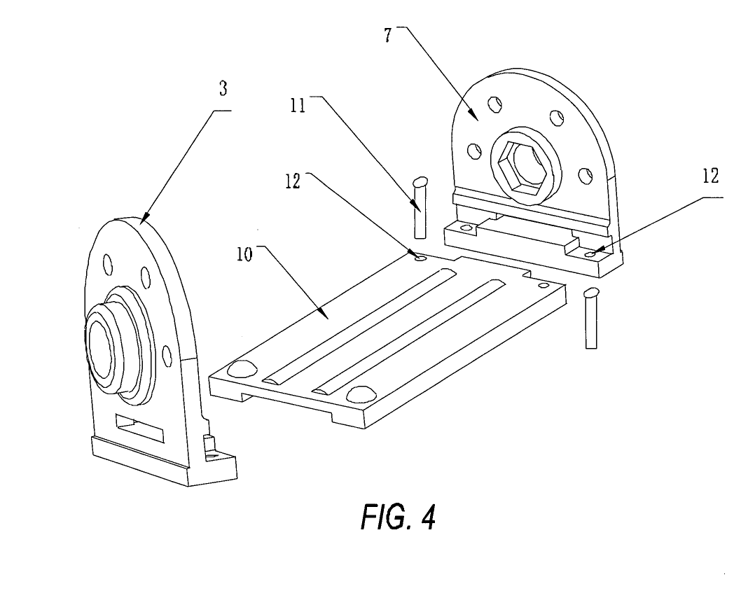

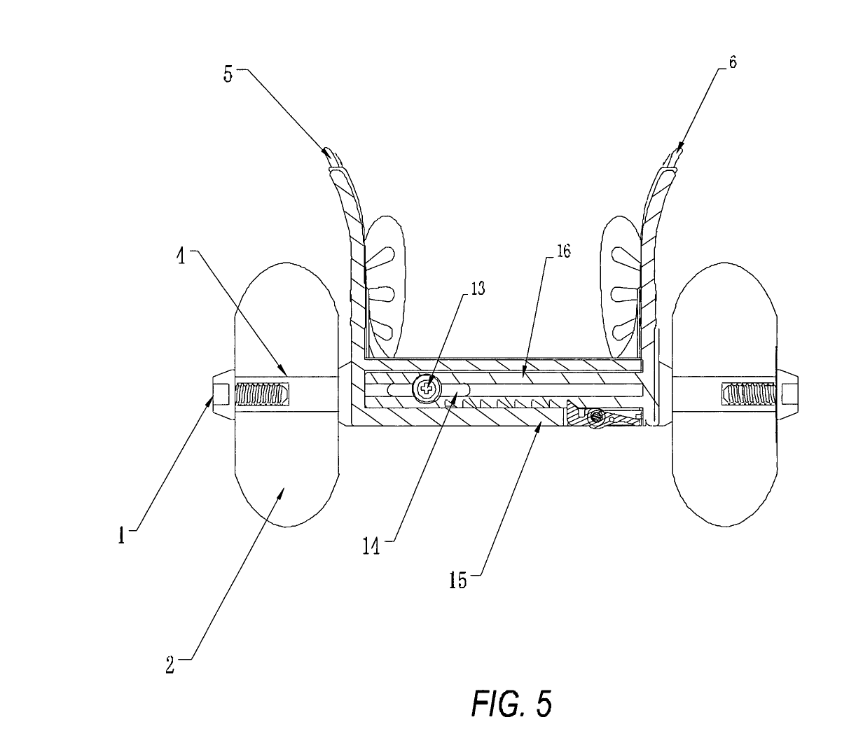

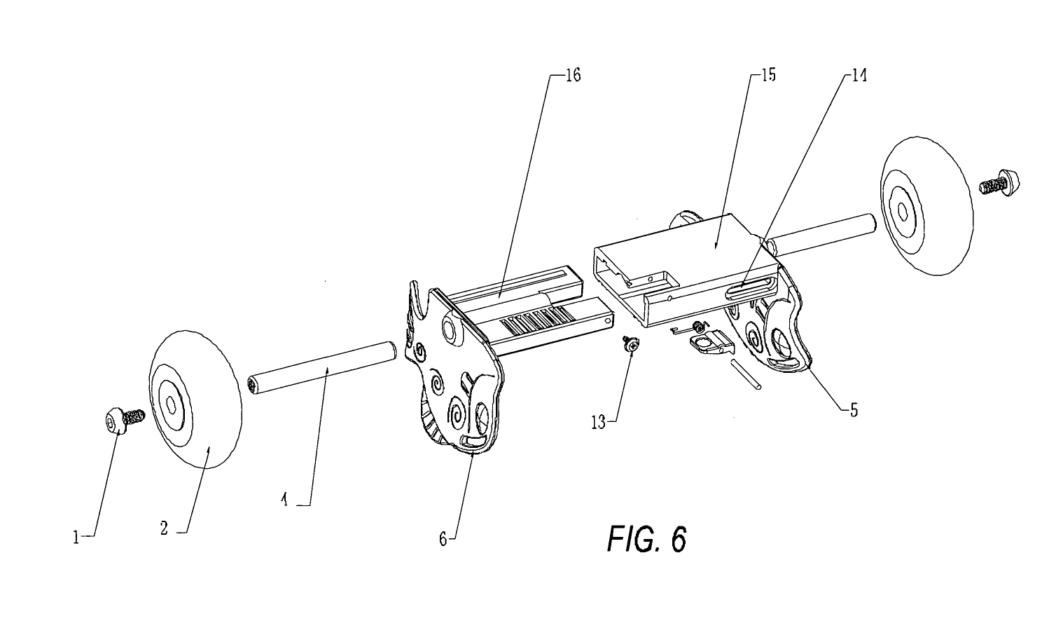

An end of the reinforced plate 10 has the penetrating hole 12, and the bottom of the right reinforced stand 6 has the penetrating hole 12, and the fixed axle 1 is installed into the penetrating hole 12, and the fixed axle 1 is passed through the penetrating hole 12 between the right reinforced stand 7 and the reinforced plate 10 (as shown in FIGS. 3 and 4).

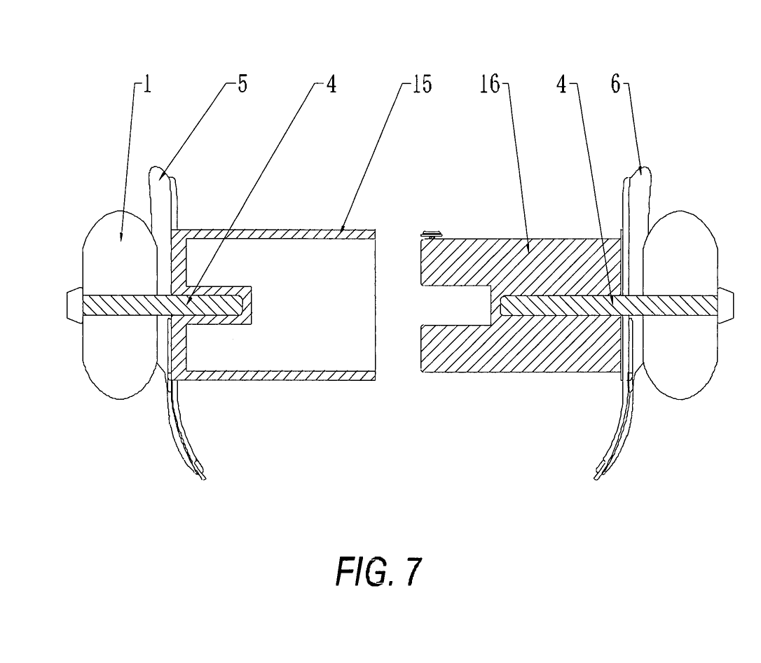

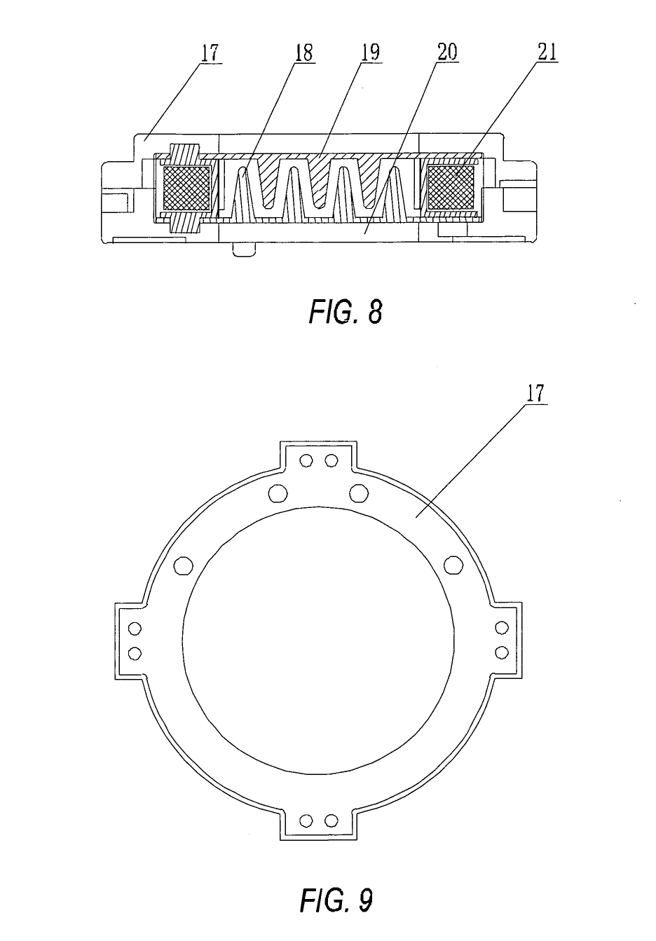

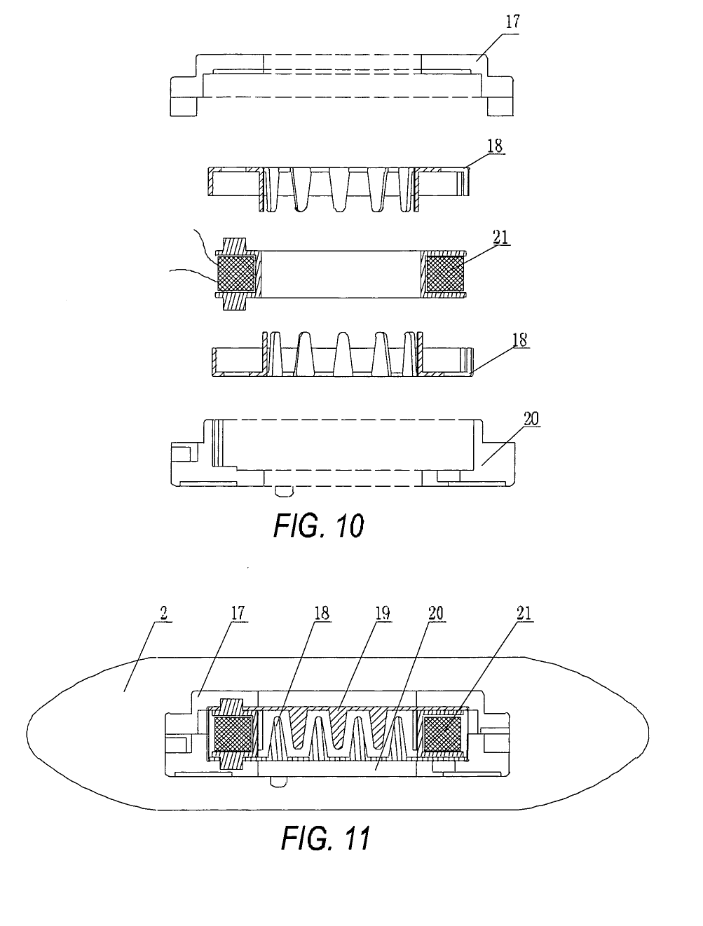

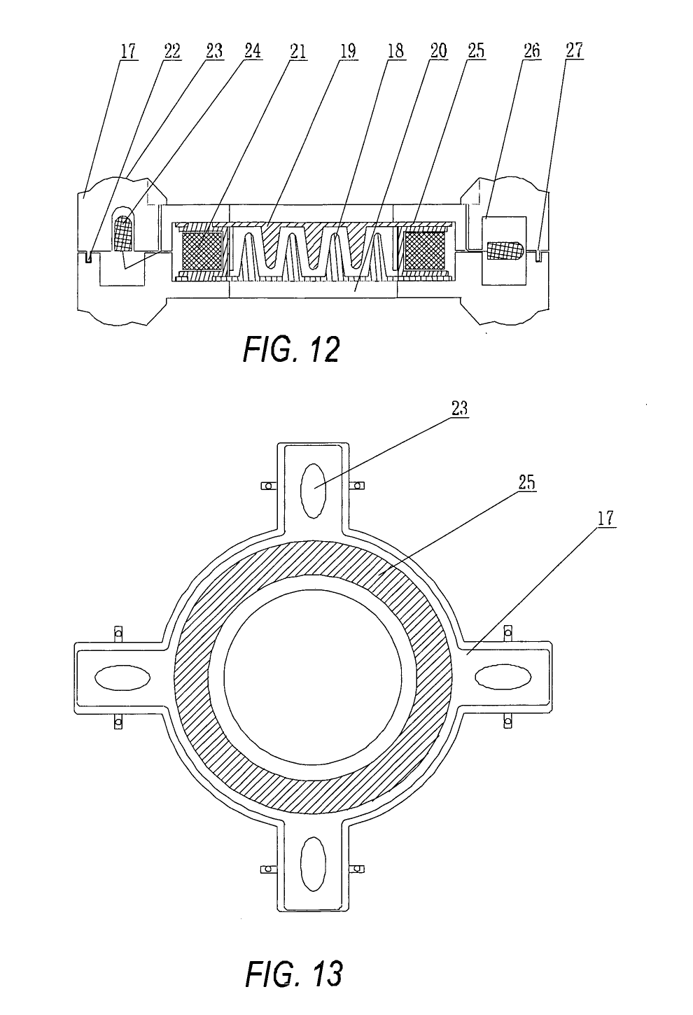

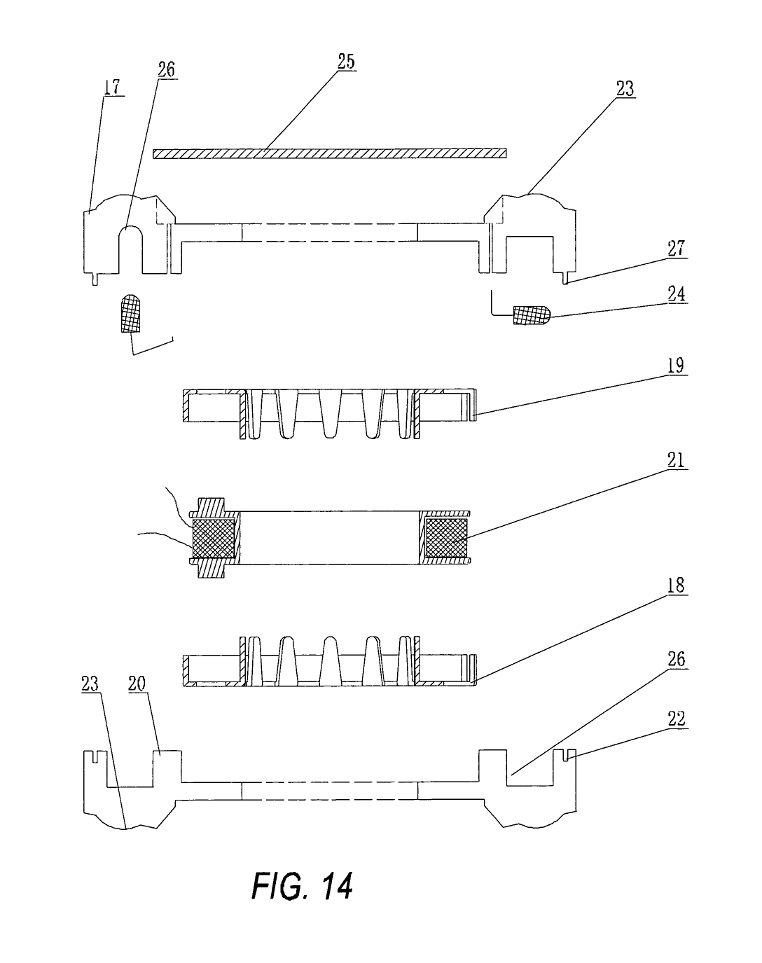

In a second preferred embodiment of the present invention, the metal screw rod 4 is installed vertically onto sidewalls of the left and right shoe stands 5, 6, and installs the light emitting wheel 2, and the bottom of the left shoe stand 5 is connected to the E-shaped bottom plate 15, and the bottom of the right shoe stand 6 is connected to the n-shaped bottom plate 16. The metal screw rod 4 is passed through the left shoe stand 5 and extended into the E-shaped bottom plate 15, and another metal screw rod 4 is passed through the right shoe stand and extended into the n-shaped bottom plate 16. The left shoe stand 5 and the E-shaped bottom plate 15 are integrally formed into a structure made by plastic injection molding. The metal screw rod 4 is extended into the protruding pillar of the E-shaped bottom plate 15, and another metal screw rod 4 is extended to the n-shaped b bottom plate 16 and at a position proximate to the n-shaped opening, and proximate to the bottom of the n-shaped opening of the n-shaped bottom plate 16 as shown in FIG. 7. When the E-shaped bottom plate 15 is engaged and latched with the n-shaped bottom plate 16, the left and right adjacent metal screw rods 4 in the bottom plate of the skating shoes are provided for supporting the weight of the light emitting wheels 2 to improve the structural strength of the skating shoe with a single-fulcrum axle.

A lateral of the E-shaped bottom plate 15 of the left shoe stand 5 includes the traveling slot 14, and a lateral of the n-shaped bottom plate 16 of the right shoe stand 16 includes the traveling screw 13 extended into the traveling slot 14 for controlling the movement and adjusting the traveling route between the E-shaped bottom plate 15 of the left shoe stand 5 and the n-shaped bottom plate 16 of the right shoe stand 6. The metal screw rod 4 is passed through the sidewall of the left shoe stand 5 and exposed from the portion having the light emitting wheel 2, and the light emitting wheel 2 is fixed onto the metal screw rod 4 by the screw 1. The metal rod 4 is passed through the sidewall of the right shoe stand 6 and exposed from the portion having the light emitting wheel 2, and the light emitting wheel 2 is fixed onto the metal screw rod 4 by the screw 1.

In a third preferred embodiment of the present invention, the light emitting wheel includes the upper protecting casing 17 and the lower protecting casing 20, and the upper protecting casing 17 and the lower protecting casing 20 are engaged to form a hollow box. The upper protecting casing 17 and the lower protecting casing 20 include a coil module consisted of the lower conducting stand 18, the upper conducting stand 19 and the coil 21, and covered by the upper and lower protecting casings 17, 20. The upper and lower protecting casings 17, 20 contain two light emitting wheels therein and formed integrally as a whole, such that when the rear-wheel skating shoe with such light emitting wheels hits an object accidentally during its use, the coil module consisting of the lower conducting stand 18, the upper conducting stand 19 and the coil 21 are covered and protected by the upper and lower protecting casings 17, 20, such that the coil module will not be deformed or damaged easily. Even if the coil module is collided, short circuits or broken circuits will occur easily.

In a fourth preferred embodiment of the present invention, the light emitting wheel 2 includes the upper protecting casing 17 and the lower protecting casing 20, and the upper protecting casing 17 and the lower protecting casing 20 are engaged to form a hollow box. The upper protecting casing 17 and the lower protecting casing 20 contain a coil module consisting of the lower conducting stand 18, the upper conducting stand 19 and the coil 21. An external side of the upper protecting casing 17 includes the circuit board 25 and an end of an internal side of the upper protecting casing 17 has the insert pillar 27, and an end of the internal side of the upper protecting casing 17 has the U-shaped opening 26, and the U-shaped opening 26 contains the light emitting diode tube 24 connected to the circuit board 25. An internal side of the lower protecting casing 20 includes the insert hole 22, and an end of an internal side of the lower protecting casing 20 has the U-shaped opening 26, and the insert pillar 27 of the upper protecting casing 27 corresponds to the insert hole 22 of the lower protecting casing 20, such that when the upper and lower protecting casings 17, 20 are engaged with each other, the insert pillar 27 is fixed into the insert hole 22.

External sides of the upper and lower protecting casings 17, 20 have T-shaped surface 23 for improving the brightness of the light emitting diode tube 24. The U-shaped opening 26 of the upper protecting casing 17 has a light emitting diode tube 24 with its lamp heads pointing at the external side of the upper protecting casing 17, and also pointing at the top of the upper protecting casing 17. If the light emitting wheel is hit and damaged during the use of the skating shoe, the coil module is protected by the lower protecting casing, and thus can prevent possible accidents.

The description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A rear-wheel skating shoe, comprising: a left shoe stand, a right shoe stand, a metal screw rod disposed on sidewalls of the left and right shoe stands, and a luminous wheel disposed on the metal rod, characterized in that a left reinforced stand is disposed in a sidewall of the left shoe stand, a right reinforced stand is disposed in a sidewall of the right shoe stand, and a reinforced plate is disposed at a bottom plate of the right shoe stand and connected to the right shoe stand.

2. The rear-wheel skating shoe as recited in claim 1, wherein the left shoe stand includes a press switch disposed on the bottom plate of the left shoe stand, and the press switch includes a latch element disposed at a distal end of the press switch and is hinged with the left shoe stand through an iron axle, and the bottom plate of the right shoe stand includes a plurality of ratchet positioning latch, and the distal end of the press switch on the left shoe stand is pressed onto a vertical plane of the ratchet positioning latch on the bottom plate of the right shoe stand, and the left reinforced stand, the right reinforced stand and the reinforced plate are made of metal, and the left shoe stand outside the left reinforced stand covered by a plastic material, the right shoe stand outside the right reinforced stand and the reinforced plate covered by a plastic material, and sidewalls of the left reinforced stand and the left shoe stand include common wheel axle hole, such that the metal screw rod passes through the wheel axle hole of the left shoe stand and has a luminous wheel disposed at a section of an external sidewall of the metal screw rod and fixed onto the metal screw rod by a screw.

3. The rear-wheel skating shoe as recited in claim 1, wherein the reinforced plate has a through hole disposed at a distal end of the reinforced plate, a through hole disposed at a bottom of the right reinforced stand, and a fixed axle installed into the through hole, and the right reinforced stand and the right reinforced plate are coupled by the fixed axle that passes the through holes, and the right reinforced stand and the right reinforced plate are integrally formed as a whole by metal manufacturing.

4. The rear-wheel skating shoe as recited in claim 1, wherein the bottom of the left shoe stand is connected to an E-shaped bottom plate, and the bottom of the right shoe stand is connected to an n-shaped bottom plate, and the metal screw rod is passed through the left shoe stand and extended into the E-shaped bottom plate, and another screw is passed through the right shoe stand and extended into the n-shaped bottom plate.

5. The rear-wheel skating shoe as recited in claim 1, wherein the lateral of the E-shaped bottom plate of the left shoe stand has a traveling slot, and the lateral of the n-shaped bottom plate of the right shoe stand has a traveling screw extended into the traveling slot, and the left shoe stand and the E-shaped bottom plate are integrally formed into a structure made by plastic injection molding, and the right shoe stand and the n-shaped bottom plate are integrally formed into a structure made by plastic injection molding, and the metal screw rod is extended into the protruding pillar of the E-shaped bottom plate, and another metal screw rod is extended to the n-shaped bottom plate and disposed at a position proximate to the bottom of the n-shaped opening.

6. The rear-wheel skating shoe as recited in claim 1, wherein the light emitting wheel includes an upper protecting casing, and a lower protecting box, and both upper and lower protecting casings are engaged to form a hollow box, and the upper and lower protecting casings have a module consisting of a lower conducting stand, an upper conducting stand, a coil.

7. The rear-wheel skating shoe as recited in claim 6, wherein the protecting box comprises a circuit board disposed on an external lateral of the protecting box, an insert pillar disposed on an internal lateral of the protecting box, a U-shaped opening disposed at the internal distal end of the protecting box, a light emitting diode tube disposed in the U-shaped opening and connected to the circuit board, an insert hole disposed on an internal distal end of the protecting box, and U-shaped opening disposed at an internal distal end of the protecting box, and the insert pillar of the protecting box corresponds to the insert hole of the protecting box, such that when the upper protecting box and the lower protecting box are engaged, the insert pillar is fixed into the insert hole.

8. The rear-wheel skating shoe as recited in claim 6, wherein the upper and lower protecting casings include a T-shaped surface for improving the brightness of the light emitting diode tube, and the U-shaped opening of the protecting box includes a light emitting diode tube with a lamp head pointing at the external lateral of the protecting box, and the U-shaped opening of the protecting box includes a light emitting tube with a lamp head pointing at the top surface of the protecting box.
